(19) United States
(12) Patent Application Publication
(10) Pub. No.: US 2007/0128404 A1
(43) Pub. Date: Jun. 7, 2007

(54) Hexalobal cross-section filaments with three major lobes and three minor lobes

(75) Inventors: Wae-Hai Tung, Marietta, GA (US); Steven K. Shibata, Hixson, TN (US)

Correspondence Address: INVISTA NORTH AMERICA S.A.R.L., THREE LITTLE FALLS CENTRE/1052, 2801 CENTERVILLE ROAD, WILMINGTON, DE, 19808, US

(73) Assignee: INVISTA NORTH AMERICA S.AR.L., Wilmington, DE (US)

(21) Appl. No.: 11/607,242

(22) Filed: Dec. 1, 2006

Related U.S. Application Data
(60) Provisional application No. 60/742,706, filed on Dec. 6, 2005.

(51) Int. Cl. B32B 33/00; B32B 3/02; D03D 27/00

(52) U.S. Cl. 428/97; 428/397; 428/92

(57) ABSTRACT

A filament comprising a synthetic polymer and characterized by a hexalobal cross-section having three major lobes and three minor lobes, and a major radius (R₁) and a minor radius (R₂). Each lobal cross-section having essentially straight side portions extending outwardly and tangent to a convex tip at each end. The ratio of the major radius (R₁) to the minor radius (R₂) defining an exterior modification ratio (R₁/R₂) of greater than 1.

### CROSS REFERENCE TO RELATED APPLICATION

This application claims the benefit of U.S. Provisional Application No. 60/742,706 filed 6 Dec. 2005.

### BACKGROUND OF THE INVENTION

The present invention relates to synthetic polymeric filaments having a hexalobal cross-sectional shape with three major lobes and three minor lobes. The filaments are especially suitable for making carpets that exhibit low sheen, glitter-free subdued luster, high color yield, and excellent anti-soiling performance.

### SUMMARY OF THE INVENTION

The present invention is a synthetic polymeric filament having a hexalobal cross-section comprising three major lobes positioned symmetrically about a central axis within a major radius (R₁) relative to said central axis and three minor lobes each positioned symmetrically between a major lobe within a minor radius (R₂) relative to said central axis wherein the ratio of major radius (R₁) to minor radius (R₂) defines an exterior modification ratio (R₁/R₂) greater than 1. Carpets comprised of synthetic polymeric filaments having a cross-section according to the invention exhibit low sheen, glitter-free subdued luster, high color yield, and excellent anti-soiling, i.e., soil hiding, performance

### BRIEF DESCRIPTION OF THE DRAWINGS

The invention will be more fully understood from the following detailed description, taken in connection with the accompanying drawings, which form a part of this application and in which:

FIG. 1 is a cross sectional view of a filament according to the present invention;

FIG. 2 is a cross sectional view of a filament corresponding to an alternate embodiment of the present invention;

FIG. 3 is a plan view of a spinneret plate for producing a filament according to the present invention;

FIG. 4 is a plan view of a spinneret plate for producing an alternative embodiment in the present invention;

FIG. 5 is a plan view of a spinneret plate for spinning the filaments used in Comparative Example 1;

FIG. 6 is a cross sectional view of a trilobal filament used in Comparative Example 1;

FIG. 7 is a plan view of a spinneret plate used for spinning the filaments in Comparative Example 4;

FIG. 8 is a cross sectional view of a trilobal filament used in Comparative Example 4.

### DETAILED DESCRIPTION OF THE INVENTION

Throughout the following detailed description of the invention, similar reference numerals have been used to refer to similar elements in all of the drawings.

The filaments of the present invention have a generally uniform solid hexalobal cross-section with three major lobes and three minor lobes. Each major lobal section has essentially straight side portions that extend outwardly and terminate in a generally convex tip. In one embodiment, the sides of the straight side portions are parallel. In another embodiment, the straight side portions can taper inwardly, from wide to narrow, moving away from the central axis in the direction of the convex tip. In yet another embodiment, the straight side portions can taper inwardly, from wide to narrow, moving toward the central axis in the direction from the convex tip to the central axis.

The major lobes of cross-section may be positioned symmetrically or asymmetrically in relation to the central axis of the filament cross-section. The length of each major lobe measuring from the central axis to the convex tip is greater than the corresponding length dimension of each minor lobe. The lobes are arranged having two sides being essentially mirror images of each other in embodiments where the lobes are symmetrical.

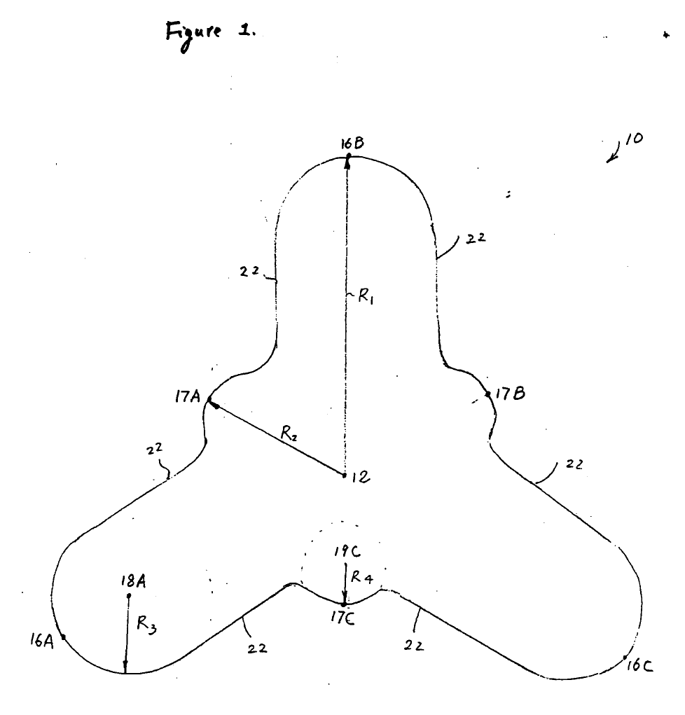

Referring now to FIG. 1, there is shown a cross section view of a filament generally indicated by reference character 10 in accordance with the present invention. A central, i.e., longitudinal, axis 12 extends through filament 10 and serves as its geometric center. The distance from central axis 12 to the outermost point(s) on the exterior contour of filament 10 from the axis define major radius (R₁) of the filament. The points are represented as 16A, 16B, and 16C on each major lobe, respectively. A minor radius (R₂) is defined as the distance from central axis 12 to the outermost point(s) of the minor lobes represented as 17A, 17B, and 17C on each minor lobe, respectively.

The distance from a respective center of generation 18A, 18B, 18C to the convex tip of each major lobe 16A, 16B, 16C is indicated by a major tip radius R₃ (only one of which is illustrated in FIG. 1 for clarity of illustration). The distance from a respective center of generation 19A, 19B, 19C to the convex tip of each minor lobe 17A, 17B, 17C is indicated by a minor tip radius R₄ (only one of which is illustrated in FIG. 1 for clarity of illustration).

Convex region 22 is disposed between each major lobe and each minor lobe as shown.

According to one embodiment, a filament 10 has an exterior modification ratio (R₁/R₂) greater than 1. In another words, the length of each major lobe (R₁) measured from the central axis of the filament to the major lobe tip is greater than the corresponding length of each minor lobe (R₂). According to another embodiment of the invention, the exterior modification ratio (R₁/R₂) is in the range of from 1.2 to about 3.5. In yet another embodiment, the exterior modification ratio (R₁/R₂) is in the range of from about 1.5 to about 2.5.

In addition, the ratio of major radius (R₁) to major tip radius (R₃) defines a “major tip ratio” (R₁/R₃) in the range of from about 2.0 to about 10.0. In another embodiment according to the invention the major tip ratio (R₁/R₃) is in the range of from about 2.5 to about 4.0.

The ratio of major radius (R₁) to minor tip radius (R₄) defines a “minor tip ratio” (R₁/R₄) in the range from about 2.0 to about 40.0. In another embodiment the minor tip ratio (R₁/R₄) is in range from about 3.75 to about 14.0.

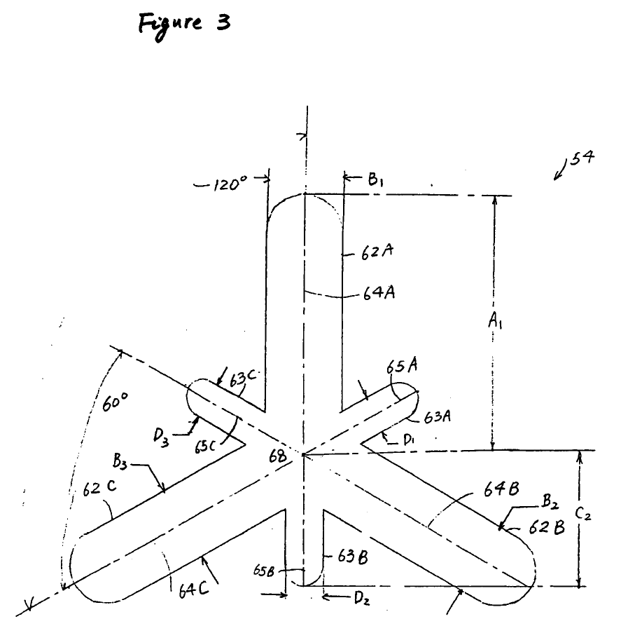

A filament, i.e., a staple fiber or continuous filament, in accordance with the present invention is prepared using a synthetic, thermoplastic melt-spinnable polymer or copolymer. Suitable polymers and copolymers include polyamides, polyesters, polyolefins, and polyacrylonitrile. Hereinafter the term “polymer” is used to mean polymers, and random and block copolymers. The polymer composition is melted and then is extruded (i.e., “spun”) through a spinneret capillary opening 54 as shown in FIG. 3 and FIG. 4 having appropriately sized orifices therein (to be described hereinafter) under conditions which vary depending upon the physical properties and/or chemical composition of the individual polymer composition being used thereby to produce a filament 10 having the desired denier, exterior modification ratio, and major or minor tip ratio. The filaments are subsequently quenched by chilled air flowing across them. The filaments are then passed over one or more heated draw coils. Subsequently, the filaments may be crimped and cut into short lengths to make staple fiber, or bulked to make bulked continuous filament (BCF) by any method known in the art.

The filaments are generally uniform in cross-section along their length and may be textured, also known as “bulked” or “crimped” according to know methods. They can be used for several different applications, including carpets, textile, or non-woven uses.

A plurality of bulked continuous filaments produced according to the invention can be gathered together to form a bulked continuous yarn. Owing to the particular desired properties of the filaments, a yarn formed there from is believed to be particularly advantageous for tufting (with or without other types of yarn(s), as desired) into carpet thereby resulting in especially desirable properties. If desired, the yarn can include other forms of filament(s).

A bonded white yarn carpet comprising filaments according to the present invention can be passed under a jet-dye printer. Using design software, the jets shoot dye onto the carpet and form designs and patterns of infinite variety and color. The carpet is then steamed, followed by a thorough rinsing, and then it is spun dry. Both loop pile and cut pile carpets can be used to produce printed carpets.

FIG. 3 illustrates one example of a spinneret plate useful for producing a filament 10′ in accordance with the present invention. The spinneret plate is a relatively massive member having an upper surface and a bottom surface. As is well appreciated by those skilled in the art, a portion of the upper surface of the spinneret plate is provided with a bore recess (not shown) whereby the plate is connected to a source of polymer. Depending upon the rheology of the polymer being extruded, the lower margins of the bore recess may be inclined to facilitate flow of polymer from the supply to the spinneret plate.

A plurality of capillary openings extend through the spinneret plate from the recessed upper surface to the bottom surface. Each capillary opening 54 serves to form one filament. Only one such capillary opening 54 is illustrated in FIG. 3. The number of capillary openings provided in a given spinneret plate thus corresponds to the number of filaments being gathered to form a predetermined number of yarn(s). As noted, additional filaments (if used) may be incorporated into the yarn in any convenient manner.

As best seen in FIG. 3, in the present invention each capillary opening 54 has six legs with three major legs 62A, 62B, 62C and three minor legs 63A, 63B, 63C. Each major leg 62A, 62B, 62C has a respective longitudinal axis 64A, 64B, 64C extending from the leg tip to central axis 68 of the capillary opening. Major axes 64A, 64B, 64C are angularly spaced from each other by one hundred twenty degrees (120°). Each minor leg 63A, 63B, 63C has a respective longitudinal axis 65A, 65B, 65C extending from the leg tip to the central axis of the filament. Minor axes 65A, 65B, 65C are angularly spaced from each other by one hundred twenty degrees (120°). Each major axe is angularly spaced from the closest minor axe about sixty degrees (60°). The major axes 64A, 64B, 64C of major legs 62A, 62B, 62C, and the minor axes 65A, 65B, 65C of minor legs 63A. 63B. 63C intersect at central axis 68 of the capillary opening.

Width dimensions of major legs 62A, 62B, and 62C are indicated by the respective reference characters B₁, B₂, B₃. Width dimensions of minor legs 63A, 63B, 63C are indicated by the respective reference characters D₁, D₂, D₃. Normally, the width of a major leg is greater than the width of a minor leg.

Length dimensions of major legs 62A, 62B, and 63C are indicated by the respective characters A₁, A₂, and A₃ (only one of which is illustrated in FIG. 3 for clarity of illustration). Length dimensions of minor legs 63A, 63B, and 63C are indicated by the respective reference characters C₁, C₂, C₃ (only one of which is illustrated in FIG. 3 for clarity of illustration). Usually, the length of a major leg is greater than the length of a minor leg.

The sides of each leg are generally parallel and extend outwardly and terminate in a convex tip. Alternatively, the leg can taper in width, from wide to narrow, in the direction from central axis 68 to the circular tip. In yet another embodiment, the straight side portions can taper in width, from wide to narrow, in the direction from the circular tip to the central axis 68 of the cross-section.

FIG. 4 illustrates another example of a spinneret plate useful for producing a filament 10 in accordance with the present invention. Capillary opening 54 shown in FIG. 4 is the same as in FIG. 3 except the convex tips of each leg have been somewhat enlarged as shown. Reference character “D” indicates the diameter of the enlarged tip located on each major leg. Reference character “d” indicates the diameter of the enlarged tip located on each minor leg.

The spinneret plate may be fabricated in any appropriate manner, as by using the laser technique described in U.S. Pat. No. 5,168,143.

The invention will now be described in greater detail in conjunction with the following, non-limiting examples.

### EXAMPLES

Test Methods

Relative Viscosity

The relative viscosity (RV) was measured by dissolving 5.5 grams of nylon 6,6 polymer in fifty cubic centimeters (50 cc) of formic acid. The RV is the ratio of the absolute viscosity of the nylon 66/formic acid solution to the absolute viscosity of the formic acid. Both absolute viscosities were measured at twenty-five degrees Centigrade (25° C.).

Carpet Glitter

The degrees of glitter for different cut-pile carpet samples were visually compared in a side-by-side comparison without knowledge of which carpets were made with which yarns. The carpets were examined by a panel of five (5) experienced examiners each familiar with carpet construction and surface texture. The glitter value was measured by the examiners on a scale of “1” to “5”, with “5” being the most glitter. The glitter rating for each sample was averaged and the samples given a rating of low, medium or high glitter based on the average rating. Carpet bulk was rated in the same manner. The glitter results are reported in Table 3.

Lab Soiling Test

The soiling test was conducted on each carpet sample using a Vetterman drum. The base color of the sample was measured using the hand held color measurement instrument sold by Minolta Corporation as “Chromameter” model CR-210.

The carpet sample was placed in the Vetterman drum. Two hundred grams (200 g) of clean nylon 101 Zytel nylon beads and fifty grams (50 g) of dirty beads (by DuPont Canada, Mississauga, Ontario) were placed on the sample. The dirty beads were prepared by mixing ten grams (10 g) of AATCC TM-122 synthetic carpet soil (by Manufacturer Textile Innovators Corp. Windsor, N.C.) with one thousand grams (1000 g) of new Nylon 101 Zytel beads. Sixteen to seventeen hundred grams (1600-1700 g) of ceramic cylindrical shaped beads [110 to 130 ½″ diameter×½″ length small beads and twenty-five to thirty-five (25 to 35) ¾%″ diameter, ¾″ length (1.91 cm diameter, 1.91 cm length) large beads] were added into the Vetterman drum. The Vetterman drum was run for five hundred (500) cycles and the sample was removed.

The color of the sample was again measured and the color change versus the control value (delta E) owing to soiling was recorded. The sample was placed back in the drum, fifty grams (50 g) of soiled beads mixture was discarded and fifty grams (50 g) of new dirty beads were added into the drum. The procedure described above was repeated for three additional five hundred (500) cycle runs.

After a total of two thousand (2000) cycles, the color change versus the control value after vacuuming was measured and recorded. Samples with high number of delta E perform worse than samples with low delta E.

Soiling Test by Foot Traffic

Soiling performance test of foot traffic on loop carpets composed of the filaments of this invention was conducted. The test involved exposing the carpets to a significant amount of soil by an actual foot traffic test. Typical foot traffic levels ranged from 150,000 to 1,000,000 at a rate of about 100,000 to 200,000 traffics per week.

The dimensions of the carpet samples can vary. The width of the carpet sample is typically about six (6) feet in order to cover the width of corridor. The length of the carpet is typically in the range about twelve (12) to eighteen (18) inches, depending upon available number of samples. In this example, commercial level loop carpet measured twelve (12) inches×six (6) feet. The carpets were vacuumed prior to each measurement.

At every twelve (12) hours, reflectance measurements were made on the different carpet samples using a Minolta Chromagraph Meter CR-210 measuring device. The CR-210 is a compact tristimulus color analyzer for measuring reflected subject color. Color readings are taken at three (3) different areas on the carpet sample. The Chromagraph Meter calculates ΔE, color difference, for each reading.

ΔE color deviation represents total color difference. The equation assumes that color space is Euclides (three-dimensional) and calculated ΔE as the square root of the sum of the squares of the three components representing the difference between coordinates of the sample and the standard, as shown by the equation below:
ΔE=\sqrt{(ΔL*)²+(Δa*)²+(Δb*)²}
where L* is a brightness variable, and a* and b* are chromaticity coordinates. When conducting soiling performance comparison test, it is important to test all of the samples at the same time and try to maintain the same floor location. Walk off mates are also used to prevent carpet samples closest to the corridor entrance from receiving an unduly amount of soil. This prevented bias in the testing. Test samples with low ΔE after foot traffic are considered to have better performances than the samples with high ΔE.

### Examples 1-3

Spinning Process

In the following examples, Nylon 6,6 filaments having various cross-sections were produced. The nylon 6,6 filaments were spun from different spinnerets of the type shown in FIGS. 3, 4 and 5.

The nylon 6,6 polymer used for all of the examples was a delustered polymer, meaning the polymer spin dope contained 0.15 weight percent of TiO₂, and had a relative viscosity (RV) of sixty-eight plus/minus approximately three units (68, +/−˜3 units). The polymer temperature before the spinning pack was controlled at about two hundred eighty-five plus/minus one degree Centigrade (285, +/−1° C.). The spinning throughput was seventy pounds (70 lbs; 31.8 kg) per hour.

The polymer was extruded through the different spinnerets and divided into two (2) eighty filament (80) segments. The capillary dimensions for the spinnerets are described below. The molten fibers were then rapidly quenched in a chimney, where cooling air at about nine degrees Centigrade (˜9° C.) was blown past the filaments at three hundred cubic feet per minute (300 cfm; 8.49 cubic meter/min) through the quench zone. The filaments were then coated with a lubricant at eight hundred yards per minute (800 yds./min; 731.52 m/min) for drawing and crimping. The coated yarns were drawn at 2197 yards per minute (2009 m/min and 2.75× draw ratio) using a pair of heated draw rolls. The draw roll temperature was one hundred ninety degrees Centigrade (190° C.). The filaments were then forwarded into a dual-impingement bulking jet (210° C. hot air) similar to that described in U.S. Pat. No. 3,525,134 to form two (2) nine hundred and ninety-five denier (995 denier; 1106 decitex), and 12.5 denier per filament (dpf) yarns (13.9 decitex per filament).

The spun, drawn, and crimped bulked continuous filament (BCF) yarns were cable-twisted to 5.0 turns per inch (tpi) on a cable twister and heat-set on a Superba heat-setting machine at setting temperature of two hundred sixty-five degrees Farenheit (265° F.; 129.4° C.).

The test yarns were then tufted into fifty-five ounce per square yard (55 oz/sq.yd; 1865 g/sq.meter) having 0.625 inch (⅝″; 1.59 cm) pile height cut pile carpets on a 1/10 inch gauge (0.254 cm) tufting machine. The tufted carpets were dyed on a continuous range dyer into wool-beige color carpets. The carpet aesthetics were assessed by a panel of experts. They were also subjected to soling tests in Vetterman drum.

### Example 1 (Comparative)

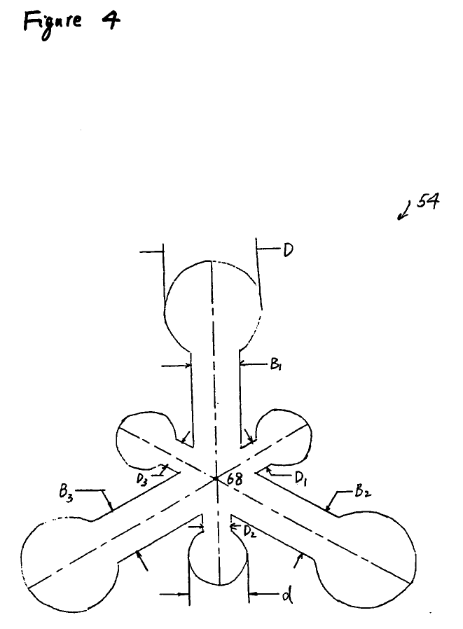

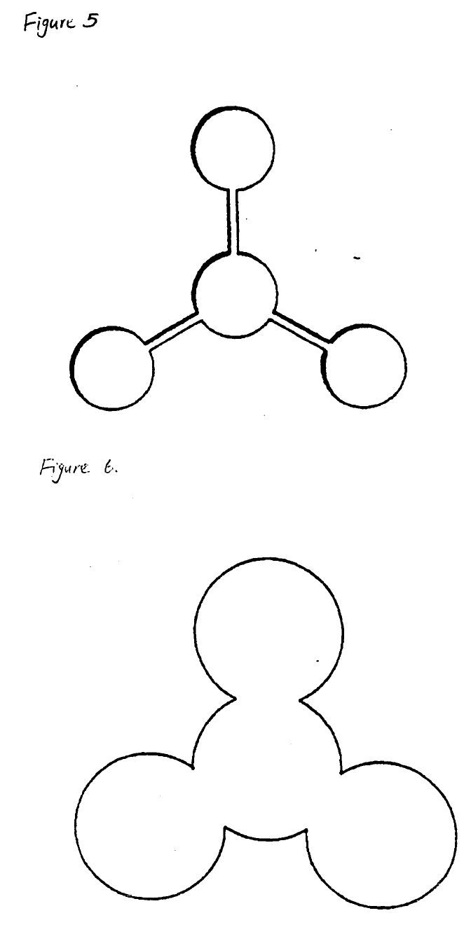

Filaments having a wavy trilobal cross-section (U.S. Pat. No. 5,108,838), as shown in FIG. 6, were made using the above described process. The filaments were spun through a spinneret capillary, as shown in FIG. 5.

### Example 2 (Current Invention)

Filaments having a hexalobal cross section according to the invention, as shown in FIG. 1, were made using the above-described process. The filaments were spun through a spinneret capillary as shown in FIG. 4. The capillary dimensions are described in Tables 1 and 2.

Table 1 presents the magnitudes of the various dimensions A₁, A₂, A₃, B₁, B₂, B₃, and D of major legs shown in FIGS. 3-4. Table 2 presents the magnitudes of the various dimensions C₁, C₂, C₃, D₁, D₂, D₃, and d of minor legs shown in FIGS. 3-4. The dimensions are in centimeters.

TABLE 1
Dimensions on Major Legs

| | A₁, A₂, A₃ | B₁, B₂, B₃ | D |
|---|---|---|---|
| Example 2 | 0.0607 | 0.0135 | 0.0269 |
| Example 3 | 0.0640 | 0.0183 | 0.0183 |

TABLE 2
Dimensions on Minor Legs

| | C₁, C₂, C₃ | D₁, D₂, D₃ | d |
|---|---|---|---|
| Example 2 | 0.0300 | 0.0081 | 0.0163 |
| Example 3 | 0.0320 | 0.0091 | 0.0091 |

### Example 3 (Current Invention)

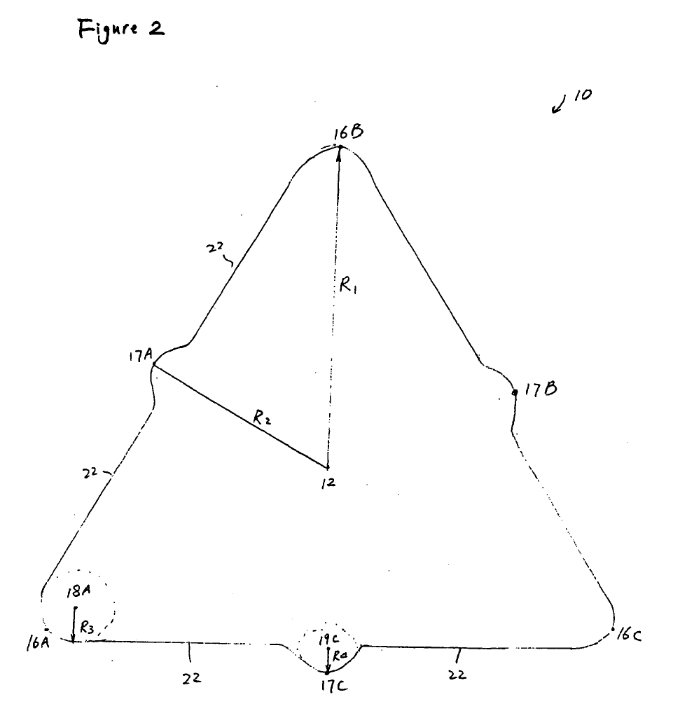

Filaments having a hexalobal cross section according to the invention, as shown in FIG. 2, were made using the above-described process. The filaments were spun through a spinneret capillary as shown in FIG. 3. The capillary dimensions are described in Tables 1 and 2.

The carpets produced using the above filaments were subjected to soiling test in a Vetterman drum as described earlier. The soiling performance was judged by delta E measurements. Carpet samples with low delta E are considered to be better soiling performers, i.e., having better anti-soiling performance, than high delta E carpets. Reducing delta E by one or more unit is considered to be a significant improvement.

The carpet samples were also assessed by a panel of experts for luster and glitter. Carpets without any glitter are more desirable than carpets with high glitter. All natural fibers have no objectionable glitter. The test results are summarized below in Table 3.

TABLE 3
Test Results

| Example | Glitter Free Luster | Soiling ΔE |
|---|---|---|
| 1 | Excellent | 20.7 |
| 2 | Good to Excellent | 17.7 |
| 3 | Excellent | 19.1 |

### Examples 4-6

Spinning Process

In the following examples, Nylon 6,6 filaments having various cross-sections were produced. The nylon 6,6 filaments were spun from different spinnerets as shown in FIGS. 3, 4, 5, and 7.

The nylon 6,6 polymer used for all of the examples was a delustered polymer, meaning that the polymer contained 0.2 weight percent of TiO₂, and had a relative viscosity (RV) of sixty-eight plus/minus approximately three units (68, +/−˜3 units). The polymer temperature before the spinning pack was controlled at about two hundred eighty-six plus/minus one degree Centigrade (286, +/−1° C.). The spinning throughput was seventy pounds five (75 lbs; 34.1 kg) per hour.

The polymer was extruded through the different spinnerets and divided into two (2) sixty-four filament (64) segments. The molten fibers were then rapidly quenched in a chimney, where cooling air at about nine degrees Centigrade (˜9° C.) was blown past the filaments at three hundred cubic feet per minute (300 cfm; 8.49 cubic meter/min) through the quench zone. The filaments were then coated with a lubricant at seven hundred and fifteen yards per minute (715 yds./min; 654 m/min) for drawing and crimping. The coated yarns were drawn at 1930 yards per minute (111 m/min and 2.75× draw ratio) using a pair of heated draw rolls. The draw roll temperature was one hundred ninety degrees Centigrade (190° C.). The filaments were then forwarded into a dual-impingement bulking jet (230° C. hot air) similar to that described in Coon, U.S. Pat. No. 3,525,134, to form two (2) twelve hundred and forty-five denier (1245 denier; 1385 decitex), and 19 denier per filament (dpf) yarns (21.1 decitex per filament).

Carpet for the anti-soiling test were prepared by cable-twisting to 4.5 turns per inch (tpi) on a cable twister and heat-set on a Supreba heat-setting machine at setting temperature of two hundred sixty-five Fahrenheit (265° F.; 129.4° C.).

These test yarns were then tufted into thirty-two ounces per square yard (32 oz/sq.yd; 1085 g/sq.meter) having 0.25 inch ( 8/32″; 0.635 cm) pile height cut pile carpets on a 1/10 inch gauge (0.254 cm) tufting machine. The tufted carpets were dyed in a beck dyer into beige color carpets of approximately L*=71.

Carpet samples for the printing test were prepared by cable-twisting to 4.8 turns per inch (tpi) on a cable twister and heat-set on a Supreba heat-setting machine at setting temperature of two hundred sixty-five Fahrenheit (265° F.; 129.4° C.).

These test yarns were then tufted into thirty-six ounces per square yard (36 oz/sq.yd; 1221 g/sq.meter) having 0.31 inch ( 5/16″; 0.794 cm) pile height cut pile carpets on a 1/10 inch gauge (0.254 cm) tufting machine.

### Example 4 (Comparative)

Filaments having a trilobal cross section as shown in FIG. 6 were made using the melting spinning process described above. The filaments were spun through a spinneret capillary as shown in FIG. 5.

### Example 5 (Current Invention)

Filaments having a hexalobal cross section according to the invention as shown in FIG. 2 were made using the melting spinning process described above. The filaments were spun through a spinneret capillary as shown in FIG. 3. The capillary dimensions are described in Tables 1 and 2.

### Example 6 (Current Invention)

Filaments having a hexalobal cross section according to the invention as shown in FIG. 2 were made using the melting spinning process described above. The filaments were spun through a spinneret capillary as shown in FIG. 4. The capillary dimensions are described in Tables 1 and 2.

### Example 7 (Comparative)

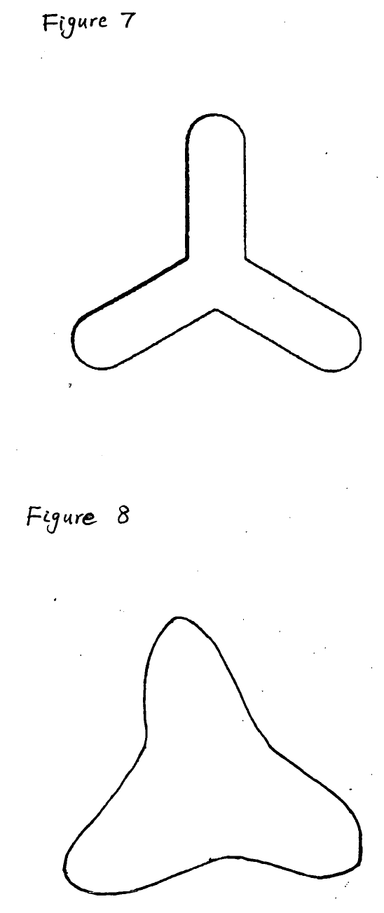

Filaments having a trilobal cross section as shown in FIG. 8 were made using a process similar to the previously described melting spinning process. The filaments were spun through a spinneret capillary as shown in FIG. 7.

Examples 4-6 were converted into 1/10 inch gauge, ¼ inch pile height, 32 ounces loop pile carpets and dyed individually to a light beige (L*≈71) color. Anti-soiling tests were performed on these samples using foot traffic. The soiling data are listed in Table 4.

TABLE 4
Soiling Test of Foot Traffic

| | ΔE @ 185, 000 foot traffics |
|---|---|
| Example 4 | 20.3 |
| Example 5 | 11.5 |
| Example 6 | 14.2 |

Examples 5-7 were converted into 1/10 inch gauge, 5/16 inch pile height, 36 ounces per square yard cut piles carpets. The carpet samples were treated with steam and printed on a Chromojet printer into multicolor patterned carpet. All carpet samples received the same amount of dyes. The printed carpets were then treated with steam to fix the dyes, and rinsed thoroughly with water to remove unused dyes. A Minolta colorimeter was used to measure the color depth (L* value) of carpet (beige section only). Carpet with low L* value have darker color than carpets with print quality. The rest results are listed in Table 5.

TABLE 5
Cut Pile Printed Carpet Evaluation

| | Patterned Carpet Color Depth & Clarity | Beige Carpet L* |
|---|---|---|
| Example 7 | Good | 56.6 |
| Example 5 | Good to Excellent | 53.0 |
| Example 6 | Excellent | 49.6 |

What is claimed is:

1. A synthetic polymeric filament characterized by a hexalobal cross-section having three major lobes positioned symmetrically to a central axis within a major radius (R₁) relative to said central axis and three minor lobes each positioned symmetrically between a major lobe and within a minor radius (R₂) relative to said central axis, wherein the ratio of major radius (R₁) to minor radius (R₂) defines an exterior modification ratio (R₁/R₂) greater than 1.

2. The filament according to claim 1 wherein the ratio R₁/R₂ is in the range of from about 1.2 to about 3.5.

3. The filament according to claim 2 wherein the ratio R₁/R₂ is in the range of from about 1.5 to about 2.5.

4. The filament according to either claim 1, claim 2, or claim 3 wherein each major lobe terminates in a convex tip having a tip radius (R₃), and the ratio of major radius (R₁) to tip radius (R₃) defines a major tip ratio (R₁/R₃) in the range of from 2.0 to 10.0.

5. The filament according to claim 4 wherein the major tip ratio (R₁/R₃) is in the range of from 2.5 to 4.0.

6. The filament according to either claim 1, claim 2, or claim 3 wherein each minor lobe has a minor tip radius (R₄), and the ratio of major radius (R₁) to minor tip radius (R₄) is in the range of from about 2.0 to about 40.0.

7. The filament according to claim 6 wherein the ratio R₁/R₄ is in the range of from 3.75 to about 14.0.

8. The filament according to either claim 4 wherein each minor lobe has a tip radius (R₄), and the ratio of major radius R₁ to tip radius (R₄) is in the range of from about 2.0 to about 40.0.

9. The filament according to claim 5 wherein the tip ratio R₁/R₄ is in the range of from 3.75 to about 14.0.

10. The filament according to claim 1 wherein the synthetic polymer is selected from the group consisting of polyamides, polyesters, polyolefins, and polyacrylonitrile.

11. A carpet comprising a plurality of bulked continuous yarns tufted into a backing, each yarn comprising a plurality of bulked continuous polymeric filaments, each of said bulked continuous filaments characterized by a hexalobal cross-section having three major lobes positioned symmetrically about a central axis within a major radius (R₁) relative to said central axis and three minor lobes each positioned symmetrically between a major lobe and within a minor radius (R₂) relative to said central axis, wherein the ratio of major radius (R₁) to minor radius (R₂) defines an exterior modification ratio (R₁/R₂) greater than 1.

12. The carpet according to claim 11 wherein the carpet is printed carpet.

13. A capillary spinneret orifice comprising: three major equally spaced and radially outwardly extending identical legs, and three minor equally spaced and radially outwardly identical legs originating at a center point in a hexalobal central region wherein two legs are essentially mirror images of each other and the length of each major leg is greater than the length of each minor leg.

14. The capillary spinneret orifice according to claim 13 wherein the width of each major leg is greater than the width of each minor leg.

15. The capillary spinneret orifice according to either claim 13 or 14 wherein each of major leg has an extended circular tip.

16. The capillary spinneret orifice according to either claim 13 or 14 wherein each of minor leg has an extended circular tip.

17. The capillary spinneret orifice according to claim 15 wherein the ratio of the diameter of the extended circular tip to the width of the major leg is in the range from about 1.0 to about 4.0.

18. The capillary spinneret orifice according to claim 16 wherein the ratio of the diameter of the extended circular tip to the width of the minor leg is in the range from about 1.0 to about 4.0.
